(19) United States
(12) Patent Application Publication
(10) Pub. No.: US 2012/0061493 A1
(43) Pub. Date: Mar. 15, 2012

(54) Removable Spray head

(76) Inventor: Chin-Tang Chung, Chang Hua Hsien (TW)

(21) Appl. No.: 12/882,091

(22) Filed: Sep. 14, 2010

(51) Int. Cl. B05B 1/00

(52) U.S. Cl. 239/589

(57) ABSTRACT

A removable spray head contains an upper cover including a top and a bottom faces, and an outer peripheral side between the top and the bottom faces, the top face including a retaining portion with an inlet, the bottom face including a distributing room, the outer peripheral side including plural holes not corresponding to the distributing room and the inlet and two stop grooves, each having a first pad, and the outer peripheral side also including a rib; a lower cover including plural spouts, an extending fence having a large-diameter stopping wall, a small-diameter pressing wall, an avoiding wall, and plural bores; a plurality of screws inserted through the bores of the extending fence to screw with the holes so that the upper and the lower covers are screwed together; a connector including an intake arranged therein and locked on the retaining portion of the upper cover.

### BACKGROUND OF THE INVENTION

1. Field of the Invention

The present invention relates to a spray head, and more particularly to a removable spray head that allows to obtain a water stop and close effect.

2. Description of the Prior Art

A shower equipment includes a wall type spray head and a held shower head, wherein the wall type spray head is fixed on a wall surface to connect with an outlet pipe of a faucet so that cold and hot waters are supplied by the faucet, and a control lever of the faucet is used to control a mix proportion of the cold and the hot waters and water amount, supplying water in a shower.

With reference to FIGS. 7 and 8, a conventional removable spray head is comprised of a casing 10 with an inlet room and an outlet panel 20, the casing 10 includes a plurality of holes 101 disposed around an outer periphery thereof, the outlet panel 20 includes a fitting portion 201 extending upward from a peripheral side thereof, the fitting portion 201 including a number of locking bores 202 mounted around an upper side of an outer periphery thereof, a stop shoulder 203 extending outward from a lower end thereof, a stopping ring 204 fitted on a lower side of the outer periphery thereof to contact with the stop shoulder 203, the casing 10 is covered onto the outlet panel 20, and a plurality of screws 30, each including a resisting loop 301 fitted, are inserted through the holes 101 of the casing 10 respectively to screw with the locking bores 202 of the fitting portion 201 of the outlet panel 20 so that the casing 10 and the outlet panel 20 are connected together, and an bottom end of the casing 10 contacts with the stopping ring 204 of the outlet panel 20, the resisting loops 301 of the screws 30 abut against the outer periphery of the casing 10, thus obtaining a water stop and close purpose.

However, the stopping ring 204 is fitted on the fitting portion 201 of the outlet panel 20 and abuts against the stop shoulder 203 of the fitting portion 201, therefore the stopping ring 204 does not has fixing function, thereby when the casing 10 is covered onto the outlet panel 20, it is easy to be pressed and then the stopping ring 204 moves and deforms, thus losing water stop and close effect to cause a water leak. Besides, the screws 30 are inserted through the holes 101 of the casing 10 to screw with the locking bores 202 of the fitting portion 201 of the outlet panel 20, according they will insert into the outlet room. If the screws 30 are not fixed precisely and properly, the resisting loops 301 of the screws 30 become lopsided to make water leak.

The present invention has arisen to mitigate and/or obviate the afore-described disadvantages.

### SUMMARY OF THE INVENTION

The primary object of the present invention is to provide a removable spray head that when the lower cover is connected with the upper cover, the avoiding wall of the extending fence of the lower cover shirks from the first pad of the outer peripheral side of the upper cover, and the first pad of the outer peripheral side of the upper cover is fixed in the stop groove to prevent the first pad from being pushed and pressed to move and deform, thus obtaining a water stop and close effect.

Another object of the present invention is to provide a removable spray head that in assembly, the screws are inserted through the bores of the lower cover to screw with the upper cover and to shrink from the distributing room so as to further lock with the hole of the inlet, hence the locking operation is capable of being separated from the distributing room and the inlet, thus preventing from water leak.

To obtain the above objectives, a removable spray head provided by the present invention contains:

an upper cover formed in a disk shape and including a top face, a bottom face, and an outer peripheral side disposed between the top and the bottom faces thereof, the top face of the upper cover including a retaining portion with an inlet mounted thereon, and the bottom face of the upper cover including a distributing room to communicate with the inlet, the outer peripheral side of the upper cover including a plurality of holes fixed thereon proximate to the upper face and not corresponding to the distributing room and the inlet, including at least one stop groove adjacent to the bottom face, each stop groove including a first pad to stop water received therein, and the outer peripheral side also including a rib formed over the first pad;

a lower cover formed in a disk shape, including a number of spouts disposed therein, including an extending fence extending upward from a circular rim thereof, and the extending fence including a large-diameter stopping wall, a small-diameter pressing wall, and an avoiding wall and a plurality of bores defined between the large-diameter stopping wall and the small-diameter pressing wall, and the lower cover being covered on the bottom face of the upper cover, and the spouts matching with the distributing room, the pressing wall matching with the stop groove and the first pad to generate a water stop and close effect;

a plurality of screws inserted through the bores of the extending fence of the lower cover to screw with the holes so that the upper and the lower covers are screwed together;

a connector including an intake arranged therein and locked on the retaining portion of the upper cover.

### BRIEF DESCRIPTION OF THE DRAWINGS

FIG. 1 is a perspective view showing the exploded components of a removable spray head according to a first embodiment of the present invention;

FIG. 2 is another perspective view showing the exploded components of a part of the removable spray head according to the first embodiment of the present invention;

FIG. 3 is a perspective view showing the assembly of the removable spray head according to the first embodiment of the present invention;

FIG. 4 is a cross sectional view showing the assembly of the removable spray head according to the first embodiment of the present invention;

FIG. 5 is a cross sectional view showing the assembly of the removable spray head according to a second embodiment of the present invention;

FIG. 6 is a cross sectional view showing the assembly of the removable spray head according to a third embodiment of the present invention;

FIG. 7 is a cross sectional showing the exploded components of a conventional removable spray head;

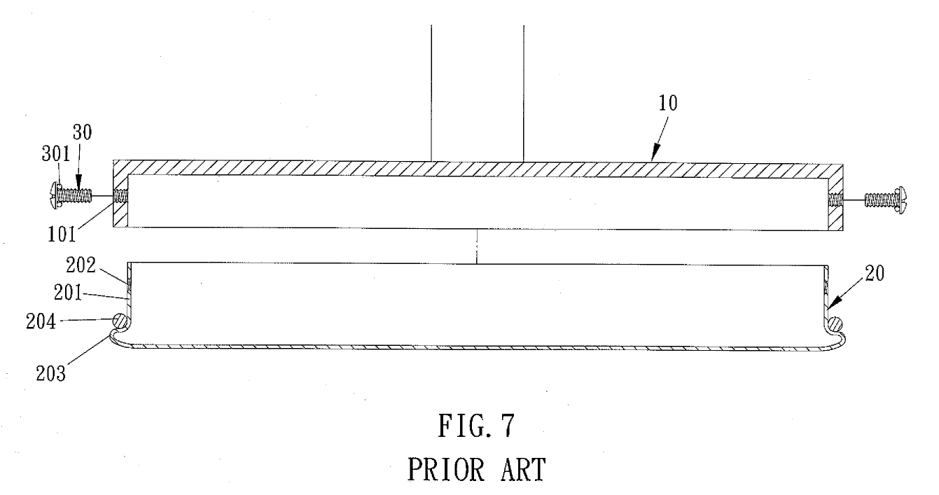

FIG. 8 is a cross sectional view showing the assembly of conventional removable spray head.

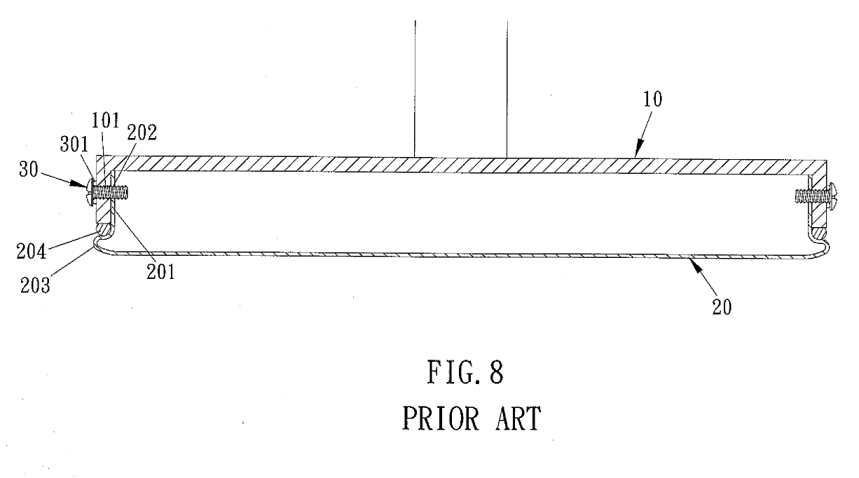

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

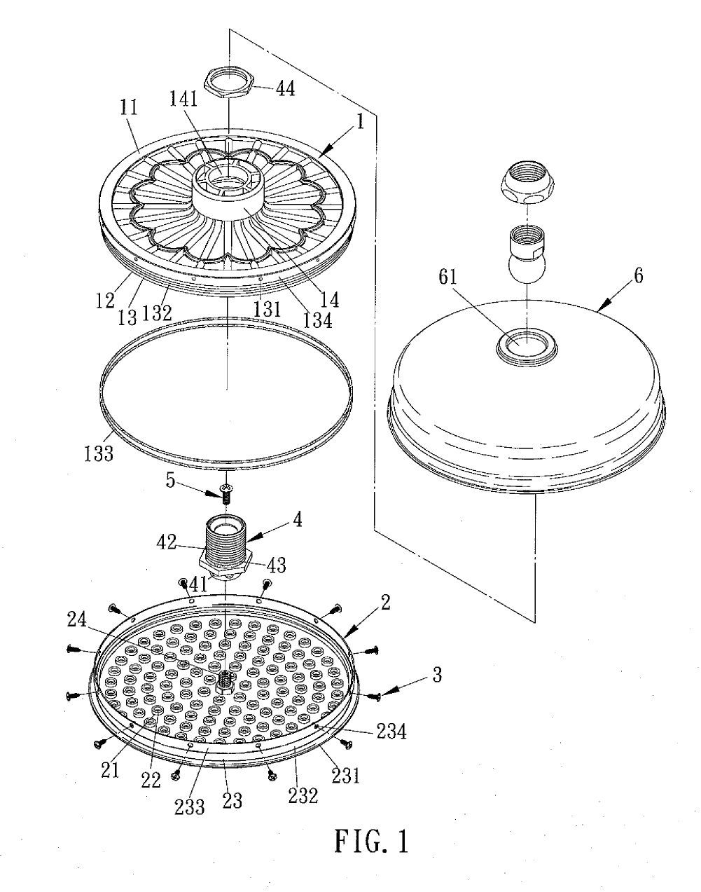

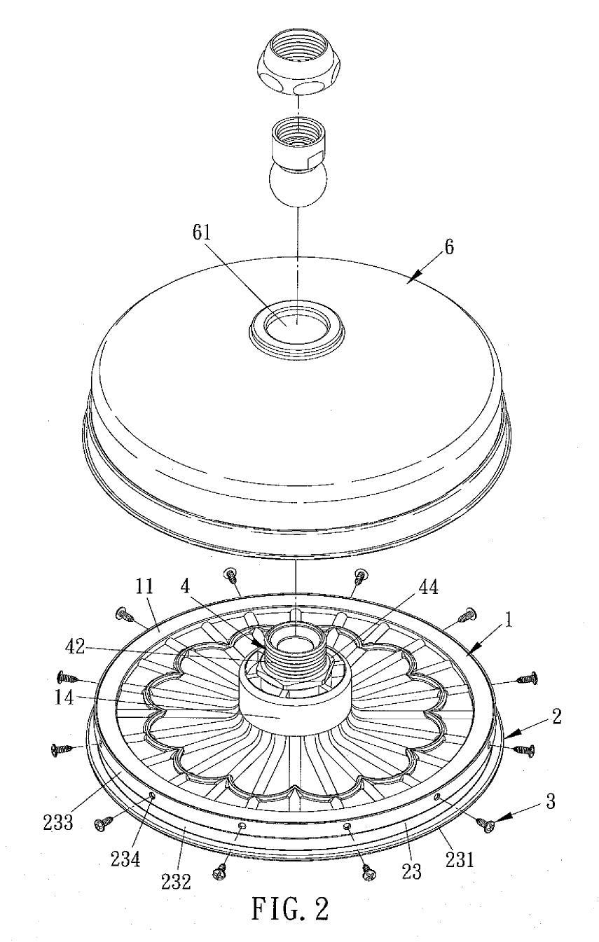

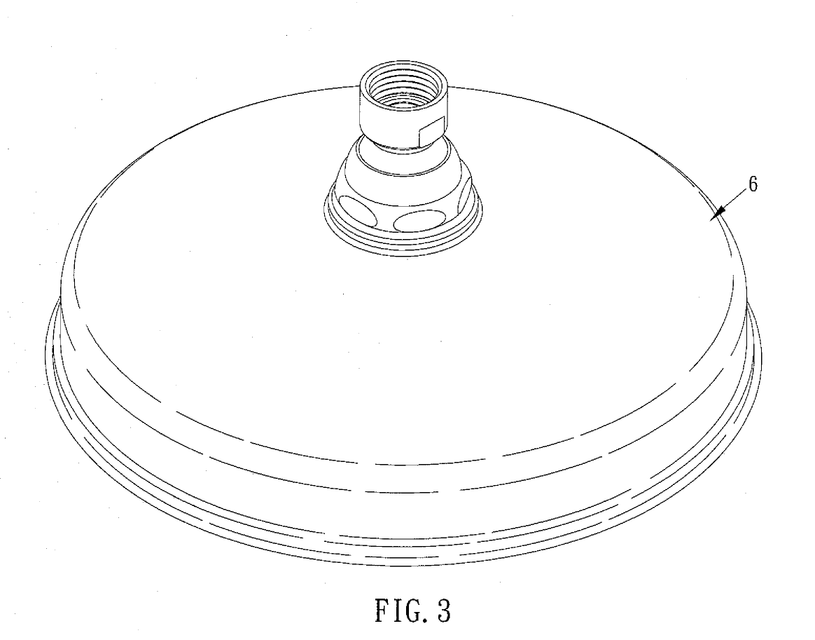

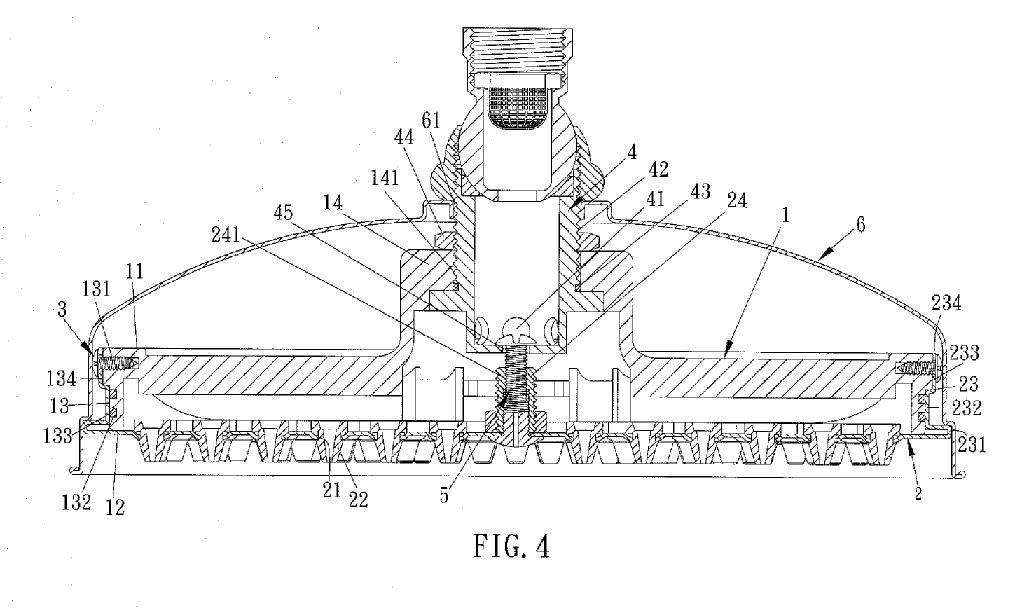

With reference to FIGS. 1-4, a removable spray head according to a first embodiment of the present invention comprises an upper cover 1, a lower cover 2, a plurality of screws 3, a connector 4, a locking assembly 5, and a casing 6, wherein

the upper cover 1 is made of plastic material, formed in a disk shape, and includes a top face 11, a bottom face 12, and an outer peripheral side 13 disposed between the top and the bottom faces 11, 12 thereof, the top face 11 of the upper cover 1 includes a retaining portion 14 with an inlet 141 mounted thereon, and the bottom face 12 of the upper cover 1 includes a distributing room 15 to communicate with the inlet 141, the outer peripheral side 13 of the upper cover 1 includes a plurality of holes 131 fixed thereon proximate to the upper face 11 and not corresponding to the distributing room 15 and the inlet 141 (i.e., the holes 131 shrink from the distributing room 15 and the inlet 141), and includes two stop grooves 132 adjacent to the bottom face 12, each stop groove 132 includes a first pad 133 to stop water received therein, and the outer peripheral side 13 also includes a rib 134 formed over the first pad 133;

the lower cover 2 is made of metal material, formed in a disk shape, includes a number of spouts 21 disposed therein and connected with a plurality of spraying members 22 respectively, includes an extending fence 23 extending upward from a circular rim thereof, and the extending fence 23 includes a large-diameter stopping wall 231, a small-diameter pressing wall 232, and an avoiding wall 233 connected with the small-diameter pressing wall 232, a diameter of the avoiding wall 233 is more than that of the large-diameter stopping wall 231 and less than that of the small-diameter pressing wall 232, the avoiding wall 233 includes a plurality of bores 234 fixed thereon, and the lower cover 2 also includes a coupling post 24 with an inner screwing aperture 241 formed on a central position of a top surface thereof;

the screws 3 are used to screw with the upper and the lower covers 1, 2;

the connector 4 includes an intake 41 arranged therein, an external thread 42 disposed on an outer side surface thereof, and a second pad 43 to stop water fitted thereon, the external thread 42 serves to screw with a lock ring 44, and includes an opening 45 mounted on a bottom surface thereof;

the locking assembly 5 is applied to screw with the connector 4 and the lower cover 2;

the casing 6 is covered onto the upper and the lower covers 1, 2 and includes an orifice 61 fixed on a central portion thereof.

In assembly, the connector 4 is fitted into the inlet 141 of the retaining portion 14 of the upper cover 1, and the lock ring 44 is screwed with the external thread 42 of the connector 4 to abut against the retaining portion 14 of the upper cover 1, the second pad 43 of the connector 4 is used to stop water, the lower cover 2 is covered on the bottom face 12 of the upper cover 1, and the spout 21 of the lower cover 2 communicates with the distributing room 15 of the upper cover 1, and the avoiding wall 233 of the extending fence 23 shrinks from the first pad 133 of the outer peripheral side 13 of the upper cover 1 so that the extending fence 23 covers the outer peripheral side 13 of the upper cover 1, and the avoiding wall 233 of the extending fence 23 of the lower cover 2 fits with the rib 134 of the outer peripheral side 13 of the upper cover 1, the small-diameter pressing wall 232 of the extending fence 23 of the lower cover 2 contacts with the outer peripheral side 13 of the upper cover 1, and the screws 3 are inserted through the bores 234 of the extending fence 23 of the lower cover 2 to screw with the holes 131 of the upper cover 1, the locking assembly 5 is inserted through the opening 45 of the connector 4 to screw with the inner screwing aperture 241 of the coupling post 24 of the lower cover 2 so that the lower cover 2 is connected with the upper cover 1 and locked by the screws 3 to actuate the small-diameter pressing wall 232 of the extending fence 23 of the lower cover 2 to move toward the stop grooves 132 of the outer peripheral side 13 of the upper cover 1 to further press the first pad 133, thus obtaining a water stop and close effect. Thereafter, the casing 6 is covered onto the upper and the lower covers 1, 2, and the orifice 61 of the casing 6 is fitted and screwed with an outer periphery of the connector 4 so that the casing 6 retains with the large-diameter stopping wall 231 of the extending fence 23 of the lower cover 2, thus finishing the removable spray head.

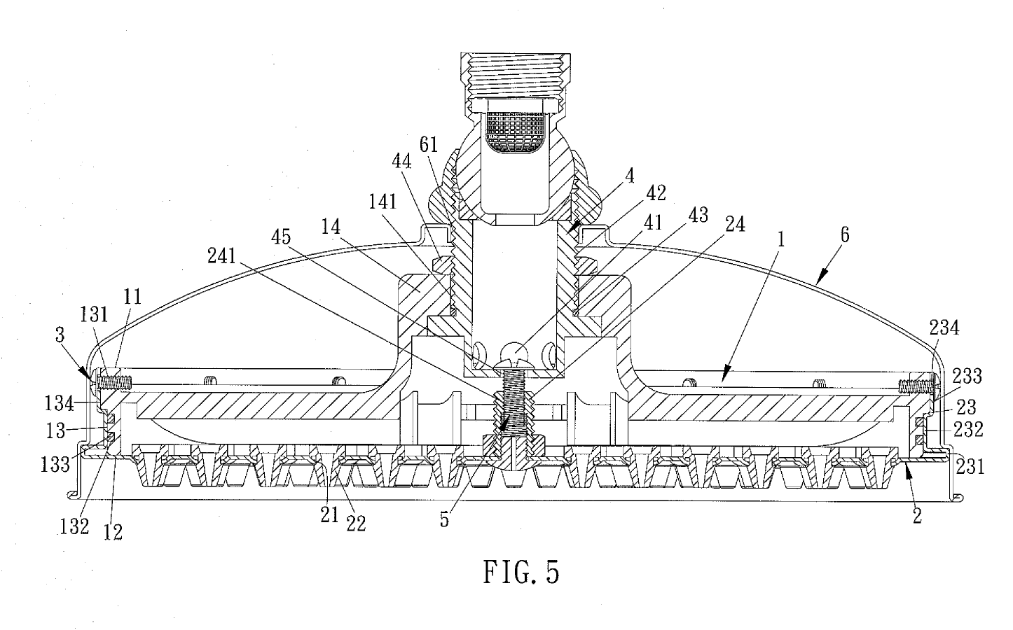

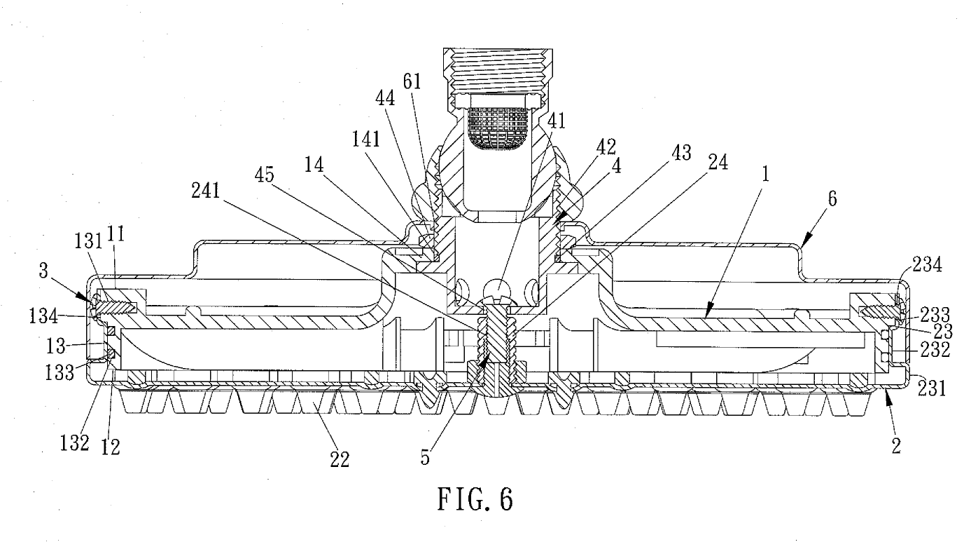

Furthermore, the holes 131 of the outer peripheral side 13 of the upper cover 1 is formed as a blind hole as shown in FIGS. 1, 2, and 4 and as a through hole as illustrated in FIG. 5. A thickness of the upper cover 1 is capable of being varied as shown in FIGS. 5 and 6.

Thereby, the removable spray head of the present invention has the following advantages:

1. When the lower cover 2 is connected with the upper cover 1, the avoiding wall 133 of the extending fence 23 of the lower cover 1 shirks from the first pad 133 of the outer peripheral side 13 of the upper cover 1, and the first pad 133 of the outer peripheral side 13 of the upper cover 1 is fixed in the stop groove 132 to prevent the first pad 133 from being pushed and pressed to move and deform, thus obtaining a water stop and close effect.

2. In assembly, the screws 3 are inserted through the bores 234 of the lower cover 2 to screw with the upper cover 1 and to shrink from the distributing room 15 so as to further lock with the hole 131 of the inlet 141, hence the locking operation is capable of being separated from the distributing room 15 and the inlet 141, preventing from water leak.

While we have shown and described various embodiments in accordance with the present invention, it is clear to those skilled in the art that further embodiments may be made without departing from the scope of the present invention.

What is claimed is:

1. A removable spray head comprising:
an upper cover formed in a disk shape and including a top face, a bottom face, and an outer peripheral side disposed between the top and the bottom faces thereof, the top face of the upper cover including a retaining portion with an inlet mounted thereon, and the bottom face of the upper cover including a distributing room to communicate with the inlet, the outer peripheral side of the upper cover including a plurality of holes fixed thereon proximate to the upper face and not corresponding to the distributing room and the inlet, including at least one stop groove adjacent to the bottom face, each stop groove including a first pad to stop water received therein, and the outer peripheral side also including a rib formed over the first pad;
a lower cover formed in a disk shape, including a number of spouts disposed therein, including an extending fence extending upward from a circular rim thereof, and the extending fence including a large-diameter stopping wall, a small-diameter pressing wall, and an avoiding wall and a plurality of bores defined between the large-diameter stopping wall and the small-diameter pressing wall, and the lower cover being covered on the bottom face of the upper cover, and the spouts matching with the distributing room, the pressing wall matching with the stop groove and the first pad to generate a water stop and close effect;
a plurality of screws inserted through the bores of the extending fence of the lower cover to screw with the holes so that the upper and the lower covers are screwed together;
a connector including an intake arranged therein and locked on the retaining portion of the upper cover.

2. The removable spray head as claimed in claim 1, wherein the upper cover is made of plastic material, and the lower cover is made of metal material.

3. The removable spray head as claimed in claim 1, wherein the spouts of the lower cover are connected with a plurality of spraying members respectively.

4. The removable spray head as claimed in claim 1 further comprising a locking assembly applied to screw with the connector and the lower cover, and the lower cover also including a coupling post with an inner screwing aperture formed on a central position of a top surface thereof, the connector also including an opening mounted on a bottom surface thereof so that the locking assembly is inserted through the opening of the connector to screw with the inner screwing aperture of the coupling post of the lower cover.

5. The removable spray head as claimed in claim 1 further comprising a casing covered onto the upper and the lower covers and including an orifice fixed on a central portion thereof and fitted on an outer periphery of the connector.
